(19) United States
(12) Patent Application Publication
(10) Pub. No.: US 2026/0281907 A1
(43) Pub. Date: Sep. 17, 2026

(54) ADAPTIVE RECEIVER DIVERSITY (ARD) WITH A LOW-POWER MODE (LPM)

(71) Applicant: QUALCOMM Incorporated, San Diego, CA (US)

(72) Inventors: Raveesh JUNEJA, Hyderabad (IN); Saranyan NAGARAJAN, Hyderabad (IN); Susmit BHATTACHARYA, Hyderabad (IN); Neeraj PUROHIT, Bengaluru (IN); Tonmoy BISWAS, Bangalore (IN); Krishnaswamy THIAGARAJAN, Bangalore (IN)

(21) Appl. No.: 19/077,851

(22) Filed: Mar. 12, 2025

(51) Int. Cl. H04W 52/02; H04L 27/152

(52) U.S. Cl. CPC H04W 52/0261; H04L 27/152

(57) ABSTRACT

Certain aspects of the present disclosure are directed towards a method for wireless communications. The method generally includes: selecting a rank of a plurality of ranks to be used for communication via at least one communication chain, the rank indicative of a number of active communication chains including the at least one communication chain, each of the plurality of ranks being associated with one or more modulation and coding scheme (MCS) thresholds used to transition between a low-power mode (LPM) or a high-performance mode (HPM); and configuring the at least one communication chain in the LPM or the HPM based on the rank and the one or more MCS thresholds associated with the rank.

### TECHNICAL FIELD

Certain aspects of the present disclosure generally relate to electronic circuits and, more particularly, to adaptive receive diversity (ARD) with a low-power mode (LPM).

### BACKGROUND

Wireless communication devices are widely deployed to provide various communication services such as telephony, video, data, messaging, broadcasts, and so on. Such wireless communication devices may transmit and/or receive radio frequency (RF) signals via any of various suitable radio access technologies (RATs) including, but not limited to, Fifth Generation (5G) New Radio (NR), Long Term Evolution (LTE), Code Division Multiple Access (CDMA), Time Division Multiple Access (TDMA), Wideband CDMA (WCDMA), Global System for Mobility (GSM), Bluetooth, Bluetooth Low Energy (BLE), ZigBee, wireless local area network (WLAN) RATs (e.g., WiFi), and the like.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station. The base station and/or mobile station may include multiple communication channels that may be used for reception or transmission.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide advantages that include reduced power consumption.

Certain aspects of the present disclosure are directed towards a method for wireless communications. The method generally includes: selecting a rank of a plurality of ranks to be used for communication via at least one communication chain, the rank indicative of a number of active communication chains including the at least one communication chain, each of the plurality of ranks being associated with one or more modulation and coding scheme (MCS) thresholds used to transition between a low-power mode (LPM) or a high-performance mode (HPM); and configuring the at least one communication chain in the LPM or the HPM based on the rank and the one or more MCS thresholds associated with the rank.

Certain aspects of the present disclosure are directed towards an apparatus for wireless communications. The apparatus generally includes memory and one or more processors coupled to the memory and configured to: select a rank of a plurality of ranks to be used for communication via at least one communication chain, the rank indicative of a number of active communication chains including the at least one communication chain, each of the plurality of ranks being associated with one or more modulation and coding scheme (MCS) thresholds used to transition between a low-power mode (LPM) or a high-performance mode (HPM); and configure the at least one communication chain in the LPM or the HPM based on the rank and the one or more MCS thresholds associated with the rank.

Certain aspects are directed towards a wireless device. The wireless device generally includes: a first receive chain; and a second receive chain including one or more adjustable components, the second receive chain configured to operate in a first mode or a second mode, the first mode being associated with adjusting the one or more adjustable components to consume less power than the second mode, wherein the second receive chain is configured to switch between operating in the first mode and the second mode based on whether one or both of the first receive chain and the second receive chain are active for communication and a modulation and coding scheme (MCS) being used for the communication.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in which aspects of the present disclosure may be practiced.

FIG. 2 is a block diagram conceptually illustrating a design of an example base station (BS) and user equipment (UE), in which aspects of the present disclosure may be practiced.

FIG. 3 is a block diagram of an example radio frequency (RF) transceiver, in which aspects of the present disclosure may be practiced.

FIG. 4 illustrates a downlink pipe (DLP) including a primary receive chain (PRx) and diversity receive chain (DRx).

FIG. 5 illustrates example operations for adaptive receive diversity (ARD) with a low-power mode (LPM), in accordance with certain aspects of the present disclosure.

FIG. 6 is a graph illustrating a set of thresholds for selecting a rank for reception and a mode of operation, in accordance with certain aspects of the present disclosure.

FIG. 7 illustrates a phase-locked loop (PLL) circuit implemented with a low-power voltage-controlled oscillator (VCO) and a high-performance VCO, in accordance with certain aspects of the present disclosure.

FIG. 8 illustrates an example receive chain configured in LPM, in accordance with certain aspects of the present disclosure.

FIG. 9 is a flow diagram illustrating example operations for wireless communications, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure are directed towards adaptive receive diversity (ARD) with a low-power mode (LPM). For example, certain aspects provide one or more receive chains that may be configured in either the LPM or a high-performance mode (HPM). For example, in LPM, a synthesizer of at least one receive chain may use a low-power voltage controller oscillator (VCO) as opposed to a high-performance VCO, may bypass one or more filters and/or amplifiers, may use a reduced number of gain states, and/or use a low-power digital filter mode. In this manner, the at least one receive chain may use less power in LPM than HPM.

As part of ARD, a wireless node (e.g., user equipment (UE)) may select a rank from a set of candidate ranks for reception. Each rank may correspond to a number (quantity) of active chains (e.g., receive chains) the wireless node uses for reception. The rank may be selected based on a modulation and coding scheme (MCS) that may be indicated as part of a grant of resources for the reception by a base station (BS). In some aspects, each of ranks may correspond to one or more MCS thresholds used to determine whether to operate in LPM or HPM. For example, for the given rank selected as part of ARD, the MCS may be compared to one or more thresholds associated with that rank. Based on the comparison, the wireless node may configure the receive chain in either LPM or HPM, as described in more detail herein. While operating in LPM may increase overall phase noise and reduce signal-to-noise ratio (SNR), the SNR may still be above a threshold per specifications for the MCS to be used.

While some examples described herein are described with respect to receive chains, certain aspects of the present disclosure may be applied to transmit chains in a similar manner. For example, the rank (e.g., number of transmit chains) may be adjusted depending on the MCS used for transmission. Based on the MCS thresholds for that rank, an LPM VCO or an HPM VCO may be used in a synthesizer for the transmit chain.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Wireless System

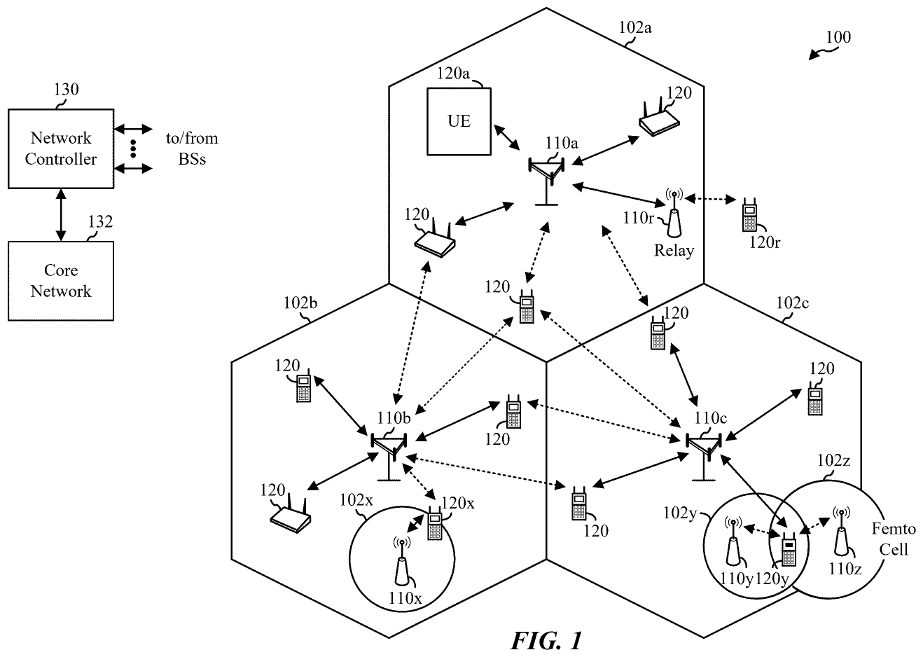

FIG. 1 illustrates an example wireless communications network 100, in which aspects of the present disclosure may be practiced. For example, the wireless communications network 100 may be a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation/Third Generation (2G/3G) network), or may be configured for communications according to an IEEE standard such as one or more of the 802.11 standards, etc.

As illustrated in FIG. 1, the wireless communications network 100 may include a number of base stations (BSs) 110a-z (each also individually referred to herein as “BS 110” or collectively as “BSs 110”) and other network entities. A BS may also be referred to as an access point (AP), an evolved Node B (eNodeB or eNB), a next generation Node B (gNodeB or gNB), or some other terminology.

A BS 110 may provide communication coverage for a particular geographic area, sometimes referred to as a “cell,” which may be stationary or may move according to the location of a mobile BS. In some examples, the BSs 110 may be interconnected to one another and/or to one or more other BSs or network nodes (not shown) in wireless communications network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with one or more user equipments (UEs) 120a-y (each also individually referred to herein as “UE 120” or collectively as “UEs 120”) in the wireless communications network 100. A UE may be fixed or mobile and may also be referred to as a user terminal (UT), a mobile station (MS), an access terminal, a station (STA), a client, a wireless device, a mobile device, or some other terminology. A user terminal may be a wireless device, such as a cellular phone, a smartphone, a personal digital assistant (PDA), a handheld device, a wearable device, a wireless modem, a laptop computer, a tablet, a personal computer, etc.

The BSs 110 are considered transmitting entities for the downlink and receiving entities for the uplink. The UEs 120 are considered transmitting entities for the uplink and receiving entities for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink. Nᵤₚ UEs may be selected for simultaneous transmission on the uplink, N_{dn} UEs may be selected for simultaneous reception on the downlink. Nᵤₚ may or may not be equal to N_{dn}, and Nᵤₚ and N_{dn} may be static values or can change for each scheduling interval. Beam-steering or some other spatial processing technique may be used at the BSs 110 and/or UEs 120.

The UEs 120 (e.g., 120x, 120y, etc.) may be dispersed throughout the wireless communications network 100, and each UE 120 may be stationary or mobile. The wireless communications network 100 may also include relay stations (e.g., relay station 110r), also referred to as relays or the like, that receive a transmission of data and/or other information from an upstream station (e.g., a BS 110a or a UE 120r) and send a transmission of the data and/or other information to a downstream station (e.g., a UE 120 or a BS 110), or that relays transmissions between UEs 120, to facilitate communication between devices.

The BSs 110 may communicate with one or more UEs 120 at any given moment on the downlink and uplink. The downlink (i.e., forward link) is the communication link from the BSs 110 to the UEs 120, and the uplink (i.e., reverse link) is the communication link from the UEs 120 to the BSs 110. A UE 120 may also communicate peer-to-peer with another UE 120.

The wireless communications network 100 may use multiple transmit and multiple receive antennas for data transmission on the downlink and uplink. BSs 110 may be equipped with a number Nₐₚ of antennas to achieve transmit diversity for downlink transmissions and/or receive diversity for uplink transmissions. A set Nᵤ of UEs 120 may receive downlink transmissions and transmit uplink transmissions. Each UE 120 may transmit user-specific data to and/or receive user-specific data from the BSs 110. In general, each UE 120 may be equipped with one or multiple antennas. The Nᵤ UEs 120 can have the same or different numbers of antennas.

The wireless communications network 100 may be a time division duplex (TDD) system or a frequency division duplex (FDD) system. For a TDD system, the downlink and uplink share the same frequency band. For an FDD system, the downlink and uplink use different frequency bands. The wireless communications network 100 may also utilize a single carrier or multiple carriers for transmission. Each UE 120 may be equipped with a single antenna (e.g., to keep costs down) or multiple antennas (e.g., where the additional cost can be supported).

A network controller 130 (also sometimes referred to as a “system controller”) may be in communication with a set of BSs 110 and provide coordination and control for these BSs 110 (e.g., via a backhaul). In certain cases (e.g., in a 5G NR system), the network controller 130 may include a centralized unit (CU) and/or a distributed unit (DU). In certain aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

In certain aspects of the present disclosure, the BSs 110 and/or the UEs 120 may include one or more communication chains that may be operated in either a low-power mode (LPM) or a high-performance mode (HPM), as described in more detail herein.

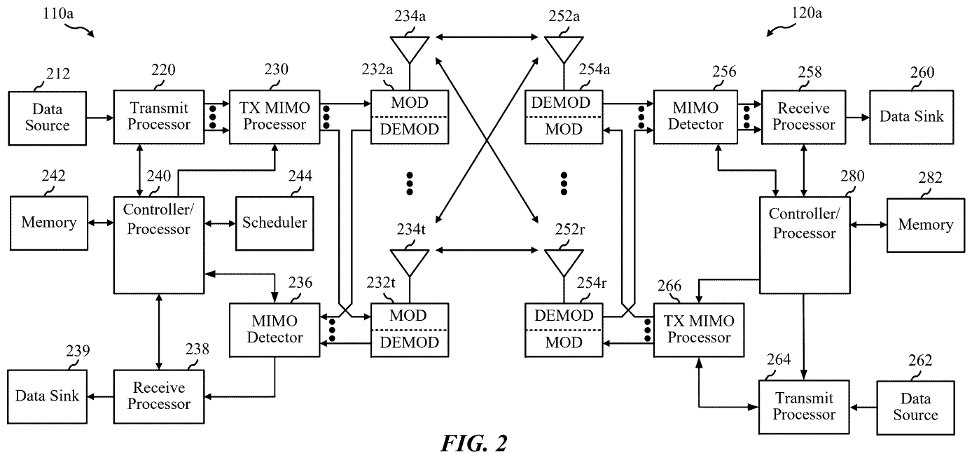

FIG. 2 illustrates example components of BS 110a and UE 120a (e.g., from the wireless communications network 100 of FIG. 1), in which aspects of the present disclosure may be implemented.

On the downlink, at the BS 110a, a transmit processor 220 may receive data from a data source 212, control information from a controller/processor 240, and/or possibly other data (e.g., from a scheduler 244). The various types of data may be sent on different transport channels. For example, the control information may be designated for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be designated for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS).

A transmit (TX) multiple-input, multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink signals from the BS 110a and may provide received signals to the transceivers 254a-254r, respectively. The transceivers 254a-254r may condition (e.g., filter, amplify, downconvert, and digitize) a respective received signal to obtain input samples. Each demodulator (DEMOD) in the transceivers 254a-254r may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. The memories 242 and 282 may also interface with the controllers/processors 240 and 280, respectively. A scheduler 244 may schedule UEs for data transmission on the downlink and/or uplink.

In certain aspects of the present disclosure, the transceivers 232 and/or the transceivers 254 may include one or more communication chains that may be operated in either a LPM or a HPM.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The system bandwidth may also be partitioned into subbands. For example, a subband may cover multiple resource blocks (RBs).

### Example RF Transceiver

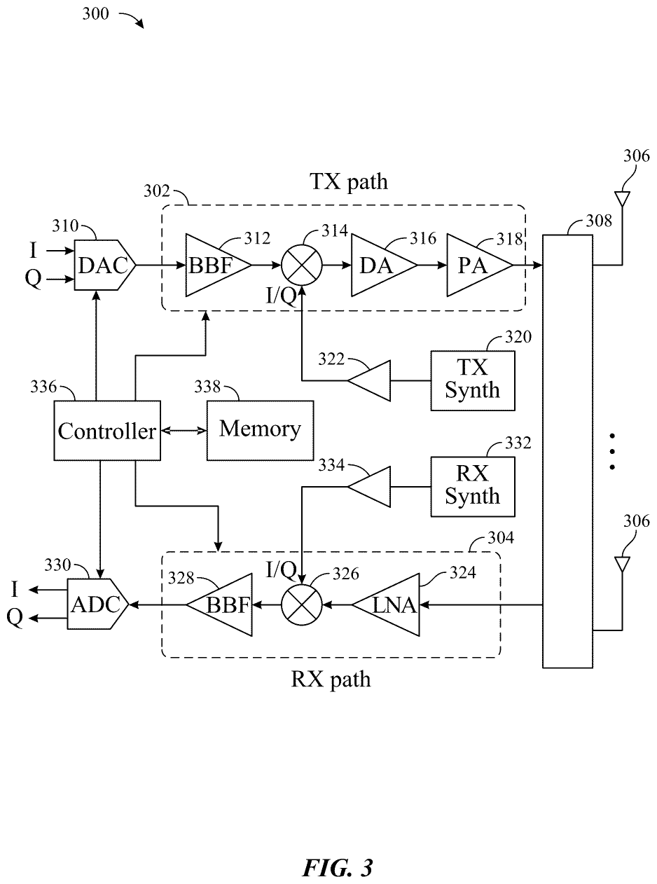

FIG. 3 is a block diagram of an example radio frequency (RF) transceiver circuit 300, in accordance with certain aspects of the present disclosure. The RF transceiver circuit 300 includes at least one transmit (TX) path 302 (also known as a “transmit chain”) for transmitting signals via one or more antennas 306 and at least one receive (RX) path 304 (also known as a “receive chain”) for receiving signals via the antennas 306. When the TX path 302 and the RX path 304 share an antenna 306, the paths may be connected with the antenna via an interface 308, which may include any of various suitable RF devices, such as a switch, a duplexer, a diplexer, a multiplexer, and the like.

Receiving in-phase (I) and/or quadrature (Q) baseband analog signals from a digital-to-analog converter (DAC) 310, the TX path 302 may include a baseband filter (BBF) 312, a mixer 314, a driver amplifier (DA) 316, and a power amplifier (PA) 318. The BBF 312, the mixer 314, the DA 316, and the PA 318 may be included in a radio frequency integrated circuit (RFIC). For certain aspects, the PA 318 may be external to the RFIC.

The BBF 312 filters the baseband signals received from the DAC 310, and the mixer 314 mixes the filtered baseband signals with a transmit local oscillator (LO) signal to convert the baseband signal of interest to a different frequency (e.g., upconvert from baseband to a radio frequency). This frequency-conversion process produces the sum and difference frequencies between the LO frequency and the frequencies of the baseband signal of interest. The sum and difference frequencies are referred to as the “beat frequencies.” The beat frequencies are typically in the RF range, such that the signals output by the mixer 314 are typically RF signals, which may be amplified by the DA 316 and/or by the PA 318 before transmission by the antenna(s) 306. While one mixer 314 is illustrated, several mixers may be used to upconvert the filtered baseband signals to one or more intermediate frequencies and to thereafter upconvert the intermediate frequency (IF) signals to a frequency for transmission.

The RX path 304 may include a low noise amplifier (LNA) 324, a mixer 326, and a baseband filter (BBF) 328. The LNA 324, the mixer 326, and the BBF 328 may be included in one or more RFICs, which may or may not be the same RFIC that includes the TX path components. RF signals received via the antenna(s) 306 may be amplified by the LNA 324, and the mixer 326 mixes the amplified RF signals with a receive local oscillator (LO) signal to convert the RF signal of interest to a different baseband frequency (e.g., downconvert). The baseband signals output by the mixer 326 may be filtered by the BBF 328 before being converted by an analog-to-digital converter (ADC) 330 to digital I and/or Q signals for digital signal processing.

Certain transceivers may employ frequency synthesizers with a variable-frequency oscillator (e.g., a voltage-controlled oscillator (VCO) or a digitally controlled oscillator (DCO)) to generate a stable, tunable LO with a particular tuning range. Thus, the transmit LO may be produced by a TX frequency synthesizer 320, which may be buffered or amplified by amplifier 322 before being mixed with the baseband signals in the mixer 314. Similarly, the receive LO may be produced by an RX frequency synthesizer 332, which may be buffered or amplified by amplifier 334 before being mixed with the RF signals in the mixer 326. For certain aspects, a single frequency synthesizer may be used for both the TX path 302 and the RX path 304. In certain aspects, the TX frequency synthesizer 320 and/or RX frequency synthesizer 332 may be operated with either a LPM VCO or a HPM VCO, as described in more detail herein.

A controller 336 (e.g., controller/processor 280 in FIG. 2) may direct the operation of the RF transceiver circuit 300, such as transmitting signals via the TX path 302 and/or receiving signals via the RX path 304. The controller 336 may be a processor, a digital signal processor (DSP), an application-specific integrated circuit (ASIC), a field-programmable gate array (FPGA) or other programmable logic device (PLD), discrete gate or transistor logic, discrete hardware components, or any combination thereof. A memory 338 (e.g., memory 282 in FIG. 2) may store data and/or program codes for operating the RF transceiver circuit 300. The controller 336 and/or the memory 338 may include control logic (e.g., complementary metal-oxide-semiconductor (CMOS) logic).

While FIGS. 1-3 provide wireless communications as an example application in which certain aspects of the present disclosure may be implemented to facilitate understanding, certain aspects described herein may be used for any of various other suitable systems.

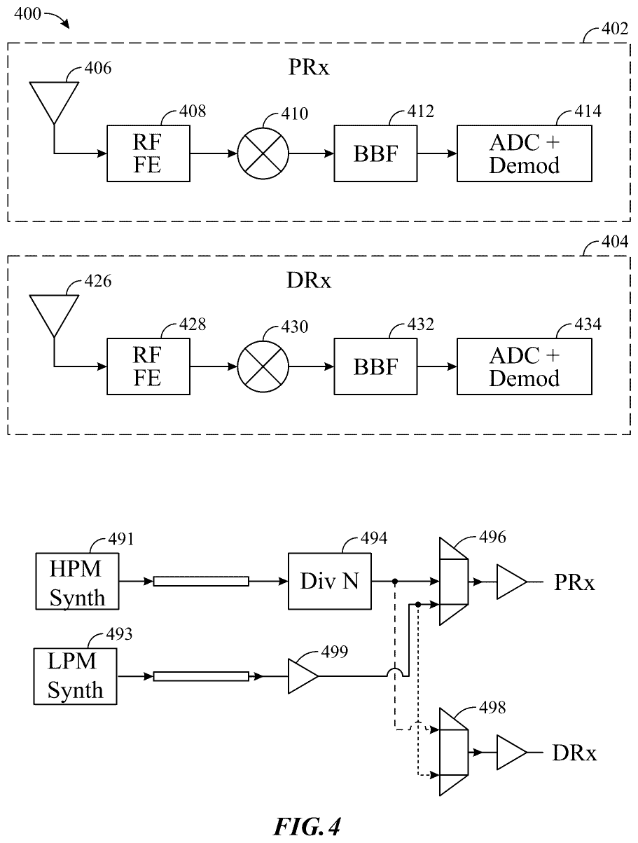

FIG. 4 illustrates a downlink pipe (DLP) 400 including a primary receive chain (PRx) 402 and diversity receive chain (DRx) 404. While two receive chains are shown, any suitable number of receive chains may be available and enabled or disabled for reception based on specifications such as a configured modulation and coding scheme (MCS) to be used. The PRx 402 may include at least one antenna 406 coupled to a radio frequency (RF) front-end (FE) 408. The RF FE 408 may include a low-noise amplifier (LNA) (e.g., corresponding to LNA 324 of FIG. 3) for amplifying a signal received from the antenna. The amplified signal may be provided to a mixer 410 (e.g., corresponding to mixer 326 of FIG. 3) for down-conversion (e.g., signal down-conversion from RF to a baseband (BB) frequency) using a LO signal (not shown). The mixer 410 generates a BB signal that is provided to a BB filter (BBF) 412 (e.g., corresponding to the BBF 328 of FIG. 3) to generate a filtered signal that is then converted from an analog domain to the digital domain via an analog-to-digital converter (ADC) (e.g., corresponding to ADC 330 of FIG. 3) and demodulated using demodulation circuitry 414.

Similarly, the DRx 404 may include at least one antenna 426 coupled to an RF FE 428. The RF FE 428 may include an LNA for amplifying a signal received from the antenna. The amplified signal may be provided to a mixer 430 for down-conversion (e.g., from RF to a baseband (BB) frequency) using another LO signal (not shown). The mixer 430 generates a BB signal that is provided to a BBF 432 to generate a filtered signal that is then converted from the analog domain to the digital domain via an ADC and demodulated using demodulation circuitry 434.

In some aspects, multiple synthesizers 491, 493 may be used to generate local oscillator signals, such as a low-power mode (LPM) synthesizer 493 (e.g., implemented using a low-power inductor-capacitor (LC) oscillator or a ring oscillator) and a high-performance mode (HPM) synthesizer 491 (e.g., implemented using an LC oscillator). The LO signal from synthesizer 491 may be provided to multiplexers 496, 498 (e.g., through a frequency divider 494, labeled “Div N”), and the LO signal from synthesizer 493 may be provided to multiplexers 496, 498 through a buffer 499. The multiplexers 496, 498 may be controlled to direct each LO signal to either the PRx or DRx (e.g., to either mixer 410 for the PRx 402 or mixer 430 for the DRx 404 for down-conversion). In some aspects, a single synthesizer may be configurable to use either a low-power voltage-controlled oscillator (VCO) or a high-performance VCO, as described in more detail herein.

### Example Techniques for Adaptive Receive Diversity (ARD) With a Low-Power Mode

Some electronic devices may support adaptive receive diversity (ARD). ARD is a technique where a device may adaptively adjust a rank (e.g., number of space-time streams or receive chains) based on specifications for reception, such as an indicated modulation and coding scheme (MCS) configured for reception. In an aspect, the number of active receive chains (or receive antennas) used may be adaptively adjusted (e.g., between using one receive antenna, two receive antennas and corresponding receive chains simultaneously, three receive antennas and corresponding receive chains simultaneously, and the like). Certain aspects of the present disclosure provide a set of configurations that can be used to save power during ARD. The configurations may be set to deliver sufficient signal-to-noise ratio (SNR) for given specifications (e.g., configured MCS) without over-allocating power (e.g., over-allocating power resulting in the SNR being well above a lower SNR threshold (limit) for the given specifications). For example, based on a configured MCS and selected rank for reception (e.g., number of active receive antennas and associated receive chains), at least one receive chain may be operated in a low-power mode (LPM), as described in more detail herein.

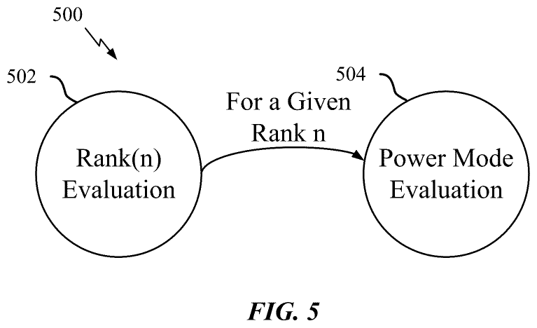

FIG. 5 illustrates example operations 500 for ARD with LPM, in accordance with certain aspects of the present disclosure. The operations 500 may be performed, for example, by a controller such as the receiver processor 238 or 258 and/or controller 240 or 280 of FIG. 2.

At block 502, the controller may perform a rank evaluation to select a rank where the rank may be indicative of a number of active communication chains (e.g., and/or active antennas) that are used in an operational mode. For example, the controller may be configured with a set of MCS thresholds that may be compared with a configured MCS to determine which rank to use. In some aspects, the MCS may be indicated by a base station (e.g., base station 110) to a UE (e.g., UE 120) in a grant scheduling resources for reception. For example, the base station may transmit downlink control information (DCI) to the UE, where the DCI indicates the resources allocated for receiving data and the MCS used to receive the data.

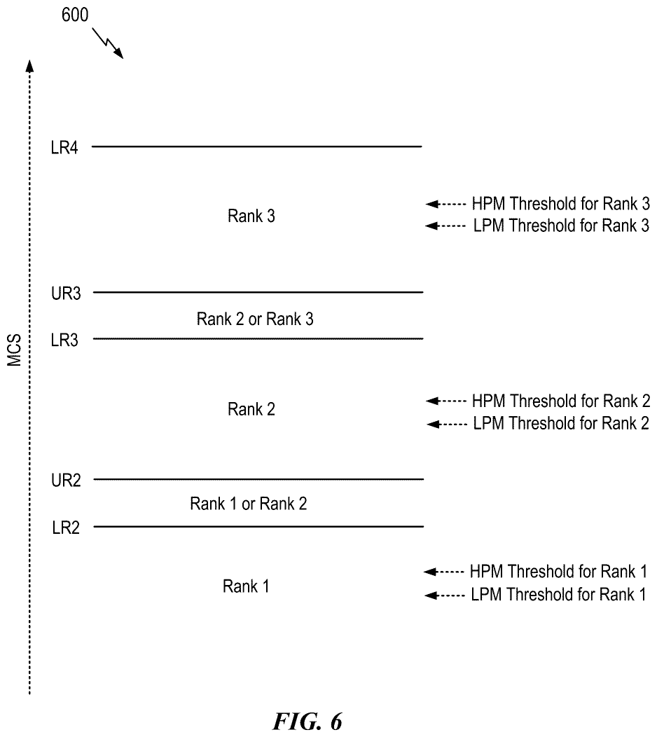

If the MCS is greater than an upper MCS threshold for rank n and less than a lower MCS threshold for rank n+1, the controller may select rank n, n being a positive integer. Otherwise, if the MCS is greater than an upper MCS threshold for rank n+1, the controller may select rank n+1. If the MCS is less than a lower MCS threshold for rank n, the controller may select rank n−1. The techniques for rank selection are described in more detail with respect to FIG. 6.

FIG. 6 is a graph 600 illustrating a set of thresholds for selecting a rank for reception, in accordance with certain aspects of the present disclosure. As shown, the controller may be configured with a series of thresholds, including a lower MCS threshold for rank 2 (LR2), an upper MCS threshold for rank 2 (UR2), a lower MCS threshold for rank 3 (LR3), an upper MCS threshold for rank 3 (UR3), a lower MCS threshold for rank 4 (LR4), and so on. If operating in rank 1, and the MCS indicated in the grant is greater than UR2, the controller may transition from rank 1 to rank 2. If operating in rank 2 (or greater), and the MCS indicated in the grant is less than LR2, then the controller may transition to rank 1. If operating in rank 2 (or less), and the MCS indicated in the grant is greater than UR3, then the controller may transition to rank 3. If operating in rank 3 (or greater), and the MCS indicated in the grant is less than LR3, then the controller may transition to rank 2. Using upper and lower thresholds for each rank provides hysteresis to prevent the rank from transitioning back and forth between ranks due to small changes in MCS.

Each MCS may be associated with an index, where higher indices correspond to MCSs with higher data rates and vice versa. Comparing the MCS to an MCS threshold may involve comparing the index for the MCS with an index threshold. In some cases, comparing the MCS to an MCS threshold may involve comparing the data rate associated with the MCS with a data rate threshold.

In some aspects, a rank used by a transmitter (e.g., base station (BS)) to transmit signals to a receiver (e.g., user equipment (UE)) may set a lower limit for how low of a rank can be selected at the receiver. For example, if a BS transmits a signal using rank 4, the UE would receive the signal using at least rank 4 as any lower rank would result in the UE being unable to decode the signal.

Once a given rank is selected, at block 504, the controller may select whether to operate in a high-performance mode (HPM) or a low-power mode (LPM). As described in more detail herein, operating in LPM may involve using a low-power voltage-controller oscillator (VCO) in the synthesizer for the at least one receive chain, disabling a low-noise amplifier (LNA) of the at least one receive chain, or disabling a baseband filter (BBF) of the at least one receive chain, given that the configured MCS is below some threshold such that the adjustments to save power still result in the SNR meeting specifications for that MCS. The UE may opportunistically operate in LPM whenever an associated MCS threshold and/or SNR specifications are met with LPM, leading to power savings.

As shown in FIG. 6, HPM and LPM thresholds may be configured for each rank. When operating in rank 1 (e.g., as selected at block 502 for ARD), if the MCS is greater than the HPM threshold for rank 1, the controller may operate the receive chain in HPM (e.g., where an HPM VCO is used for the receive chain synthesizer with LNAs and BBFs enabled). If operating in rank 1 with LPM and the configured MCS is greater than the HPM threshold for rank 1, then the controller may switch the configuration of the receive chain to operate in HPM. If operating in rank 1 with HPM and the configured MCS is less than the LPM threshold for rank 1, then the controller may switch the configuration of the receive chain to operate in LPM. Similarly, if operating in rank 2 with LPM and the configured MCS is greater than the HPM threshold for rank 2, then the controller may switch the configuration of the receive chain to operate in HPM. If operating in rank 2 with HPM and the configured MCS is less than the LPM threshold for rank 2, then the controller may switch the configuration of the receive chain to operate in LPM. Similarly, operations may be performed to select HPM or LPM for other ranks using associated HPM and LPM thresholds.

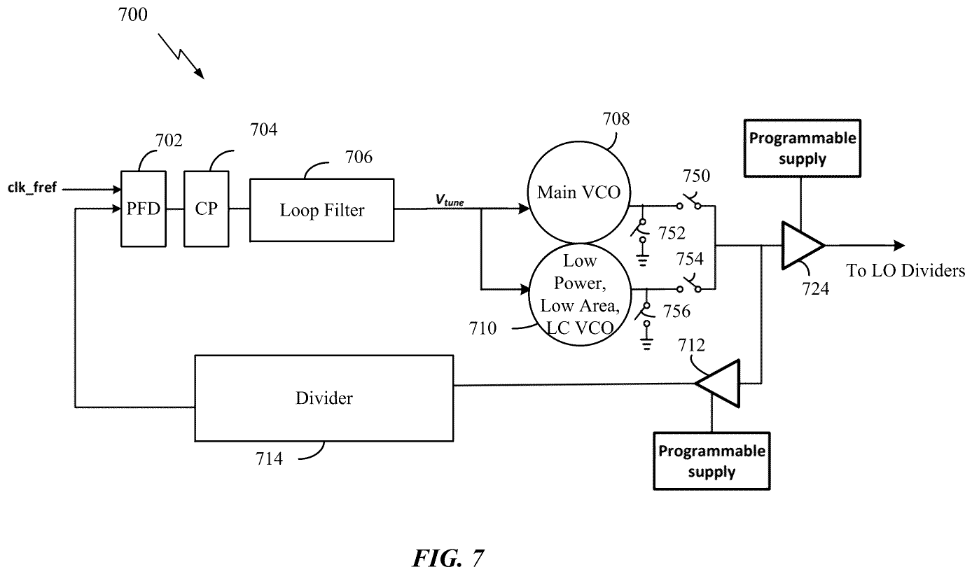

FIG. 7 illustrates a phase-locked loop (PLL) circuit 700 implemented with a low-power VCO and a high-performance VCO, in accordance with certain aspects of the present disclosure. As shown, the PLL circuit 700 may include a phase-frequency detector (PFD) 702 that receives a clock signal as a frequency reference (labeled “clk_fref”), which may be compared to a frequency-divided feedback signal from a frequency divider 714. An output signal of the PFD may be provided to a charge pump (CP) 704 to generate a current based on the phase difference between clk_fref and the frequency-divided feedback signal detected by the PFD. The current is provided to a loop filter 706 to generate a tuning voltage (Vtune). As shown, the PLL circuit 700 may include a high-performance VCO 708 and a low-power VCO 710, which may receive Vtune to generate an oscillating signal (e.g., local oscillator (LO) signal) at an output of the PLL circuit 700. As shown, the oscillating signal may be provided (e.g., through a buffer 724 with a programmable supply voltage) to one or more LO dividers. The oscillating signal may also be provided to the frequency divider 714 (e.g., through a buffer 712 with a programmable supply voltage), which may be frequency-divided to generate the frequency-divided feedback signal. As shown, a set of switches may be coupled between outputs of each of the VCOs 708, 710 and an output of the PLL circuit 700, allowing the VCOs to be selectively enabled or disabled (e.g., incorporated in the loop of the PLL circuit 700). For example, to incorporate the high-performance VCO 708 in the loop during HPM, switches 750, 756 may be closed, and the switches 752, 754 may be opened, coupling the VCO 708 to the output of the PLL circuit 700. To incorporate the low-power VCO 710 in the loop during LPM, switches 752, 754 may be closed, and the switches 750, 756 may be opened, coupling the VCO 710 to the output of the PLL circuit 700.

The low-power VCO 710 may be a VCO with a smaller area and lower power consumption than the high-performance VCO 708. VCOs 708, 710 may be implemented as inductor-capacitor (LC) VCOs, although any suitable VCO type may be used. For example, in some cases, the low-power VCO 710 may be implemented using a ring oscillator. The low-power VCO 710 may have a higher phase noise (PN) than the high-performance VCO 708. In some cases, when in LPM, the supply voltage for one or more of buffers 712, 724 may be lowered, reducing power consumption, albeit at the expense of increased phase noise. However, as described herein, the higher PN due to using the low-power VCO 710 and/or decreasing the supply voltage of buffers 712, 724 may still provide an SNR that is greater than a threshold per specifications given the configured MCS.

In some aspects, the linearity of the receiver may be reduced (e.g., by reducing the bias current of one or more BBFs of the receive chain) while still providing an SNR that is greater than a threshold per specifications given the configured MCS. For example, the linearity of the receiver chain may be set in LPM to meet the SNR threshold per specifications, given a worst-case SNR margin at room temperature, providing power savings through reduced linearity.

In some aspects, a reduced number of gain states may be used during LPM. For example, there may be twelve gain states used for the receiver (e.g., receiver 304 of FIG. 3) in HPM. The twelve gain states may range from a maximum gain setting to a minimum gain setting. The gain states may be adjusted based on a measured receive signal strength (e.g., received signal strength indicator (RSSI)). The receive signal strength may be measured by a modem (e.g., receive processor 238 and/or controller 240 of FIG. 2 or receive processor 258 and/or controller 249 of FIG. 2). Based on the receive signal strength, the gain state may be adjusted to avoid saturating the analog-to-digital converter (ADC) (e.g., ADC 330 of FIG. 3) of the receive chain. When operating in LPM, the number of gain states may be reduced, for example, to four gain states ranging from the maximum gain setting to the minimum gain setting. In this manner, based on the receive signal strength, the gain associated with the receive chain may be reduced faster (e.g., reduced using a higher gain reduction magnitude per step), reducing power consumption. The new set of gain states may result in reduced linearity while still meeting the SNR threshold per specifications given the configured MCS. In some aspects, one or more of the LNAs and BBFs of the receive chain may be bypassed in LPM to further reduce power consumption. The bypassing of the LNA(s) and/or BBF(s) may be performed while any of the gain states are active.

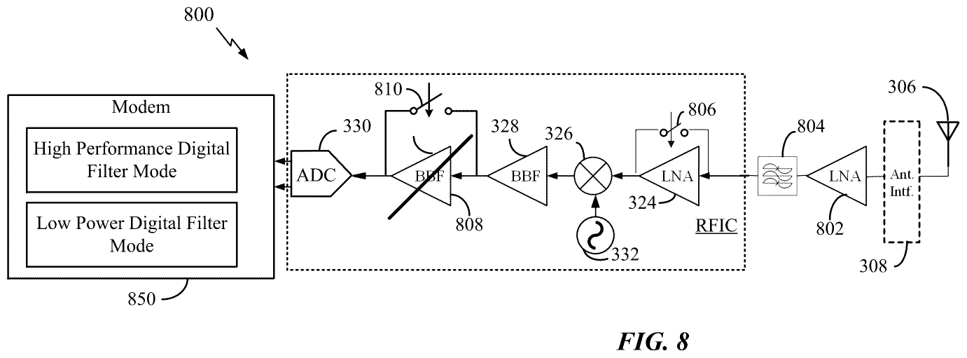

FIG. 8 illustrates an example receive chain 800 with multiple LNAs and BBFs, in accordance with certain aspects of the present disclosure. As shown, within a radio frequency integrated circuit (RFIC), there may be an LNA 324. Another LNA 802 may be implemented external to the RFIC to provide further signal amplification. The input of the LNA 802 may be coupled to the antenna 306 through an interface 308. The output of the LNA 802 may be coupled to an input of the LNA 324 through a filter 804. Filter 804 may also be implemented externally to the RFIC. As shown, the output of the mixer 326 may be coupled to the BBF 328. Another BBF 808 may be coupled to the output of the BBF 328, providing multi-stage filtering. In some aspects of the present disclosure, a bypass switch 806 may be coupled between the input and the output of LNA 324, allowing the LNA 324 to be bypassed (e.g., disabled) during LPM. It should be appreciated that a similar bypass path may be present for the LNA 802. Similarly, a bypass switch 810 may be coupled between the input and the output of the BBF 808, allowing the BBF 808 to be bypassed (e.g., disabled) during LPM. Thus, during LPM, one or more of LNA 324 or BBF 808 may be bypassed, reducing power consumption. In this manner, any combination of bypass path selection, LO synthesizer switching, gain state switching, or adjusted BBF characteristics may be provided for the LPM.

In some aspects, power savings may be implemented in the digital domain during LPM. For example, two different digital filter modes may be used, one consuming less power than the other. In some aspects, when operating in LPM, the digital filter consuming less power may be used, albeit with reduced filtering performance.

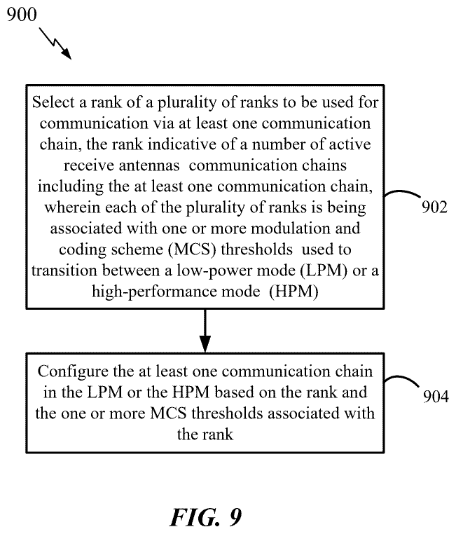

FIG. 9 is a flow diagram illustrating example operations 900 for wireless communications, in accordance with certain aspects of the present disclosure. The operations 900 may be performed, for example, by a controller of a wireless node such as the receiver processor 238 or 258 and/or controller 240 or 280 of FIG. 2.

At block 902, the controller selects a rank of a plurality of ranks to be used for communication via at least one communication chain (e.g., receive chain). The rank may be indicative of a number of active communication chains including the at least one communication chain. Each of the plurality of ranks may be associated with one or more modulation and coding scheme (MCS) thresholds used to transition between a low-power mode (LPM) or a high-performance mode (HPM). In some aspects, the rank may be selected based on a modulation and coding scheme (MCS) to be used for the communication. For example, the wireless node may receive a grant for the communication and the grant may indicate the MCS.

At block 904, the controller may configure the at least one communication chain in the LPM or the HPM based on the rank and the one or more MCS thresholds associated with the rank.

In some aspects, to configure the at least one communication chain in the LPM, the controller may compare an MCS to be used for the communication with the one or more thresholds associated with the rank. The one or more MCS thresholds may include a first MCS threshold and a second MCS threshold greater than the first MCS. To configure the at least one communication chain in the LPM or the HPM, the controller may configure the at least one communication chain in the LPM based on the MCS being less than the first MCS threshold or configure the at least one communication chain in the HPM based on the MCS being greater than the second MCS threshold.

In some aspects, the at least one communication chain may include PLL (e.g., PLL circuit 700) including a first VCO (e.g., VCO 708) and a second VCO (e.g., VCO 710), the second VCO being configured to consume less power than the first VCO. To configure the at least one communication chain, the controller may configure the PLL to use the second VCO in the LPM or use the first VCO in the HPM. In some cases, the first VCO and the second VCO may include LC VCOs. Configuring the at least one communication chain in the LPM may include bypassing at least one of an amplifier (e.g., LNA 324 of FIG. 8) or a filter (e.g., BBF 808 of FIG. 8) of the at least one communication chain.

In some aspect, to configure the at least one communication chain in the LPM, the controller may configure the at least one communication chain to use a first digital filter mode to process a received signal in a digital domain. To configure the at least one communication chain in the HPM, the controller may configure the at least one communication chain to use a second digital filter mode to process the received signal in the digital domain, the first digital filter mode consuming less power than the second digital filter mode.

In some aspects, to configure the at least one communication chain in the LPM, the controller may use a first quantity of gain states for the at least one communication chain. To configure the at least one communication chain in the HPM, the controller may use a second quantity of gain states for the at least one communication chain, the second quantity of gain states being more than the first quantity of gain states.

### Example Aspects

In addition to the various aspects described above, specific combinations of aspects are within the scope of the present disclosure, some of which are detailed below:
Aspect 1: A method for wireless communications, comprising: selecting a rank of a plurality of ranks to be used for communication via at least one communication chain, the rank indicative of a number of active communication chains including the at least one communication chain, each of the plurality of ranks being associated with one or more modulation and coding scheme (MCS) thresholds used to transition between a low-power mode (LPM) or a high-performance mode (HPM); and configuring the at least one communication chain in the LPM or the HPM based on the rank and the one or more MCS thresholds associated with the rank.
Aspect 2: The method of Aspect 1, wherein configuring the at least one communication chain in the LPM includes controlling one or more adjustable components of the at least one communication chain to consume less power as compared to the HPM.
Aspect 3: The method of Aspect 1 or 2, wherein the rank is selected based on an MCS to be used for the communication.
Aspect 4: The method of Aspect 3, further comprising receiving a grant for the communication, wherein the grant indicates the MCS.
Aspect 5: The method according to any of Aspects 1-4, further comprising comparing an MCS to be used for the communication with the one or more MCS thresholds associated with the rank, the at least one communication chain being configured in the LPM or the HPM based on the comparison.
Aspect 6: The method of Aspect 5, wherein: the one or more MCS thresholds comprise a first MCS threshold and a second MCS threshold greater than the first MCS; and configuring the at least one communication chain in the LPM or the HPM further includes: configuring the at least one communication chain in the LPM based on the MCS being less than the first MCS threshold; or configuring the at least one communication chain in the HPM based on the MCS being greater than the second MCS threshold.
Aspect 7: The method according to any of Aspects 1-6, wherein: the at least one communication chain includes a phase-locked loop (PLL) including a first VCO and a second VCO, the second VCO being configured to consume less power than the first VCO; and configuring the at least one communication chain comprises configuring the PLL to use the second VCO in the LPM or use the first VCO in the HPM.
Aspect 8: The method of Aspect 7, wherein the first VCO and the second VCO comprise inductor-capacitor (LC) VCOs.
Aspect 9: The method according to any of Aspects 1-8, wherein configuring the at least one communication chain in the LPM includes bypassing at least one of an amplifier or a filter of the at least one communication chain.
Aspect 10: The method according to any of Aspects 1-9, wherein: configuring the at least one communication chain in the LPM includes configuring the at least one communication chain to use a first digital filter mode to process a received signal in a digital domain; and configuring the at least one communication chain in the HPM includes configuring the at least one communication chain to use a second digital filter mode to process the received signal in the digital domain, the first digital filter mode consuming less power than the second digital filter mode.
Aspect 11: The method according to any of Aspects 1-10, wherein: configuring the at least one communication chain in the LPM includes using a first quantity of gain states for the at least one communication chain; and configuring the at least one communication chain in the HPM includes using a second quantity of gain states for the at least one communication chain, the second quantity of gain states being more than the first quantity of gain states.
Aspect 12: The method according to any of Aspects 1-11, wherein the rank corresponds to a quantity of communication chains in the at least one communication chain.
Aspect 13: The method according to any of Aspects 1-12, wherein the communication chain comprises a receive chain.
Aspect 14: An apparatus for wireless communications, comprising: memory; and one or more processors coupled to the memory and configured to: select a rank of a plurality of ranks to be used for communication via at least one communication chain, the rank indicative of a number of active communication chains including the at least one communication chain, each of the plurality of ranks being associated with one or more modulation and coding scheme (MCS) thresholds used to transition between a low-power mode (LPM) or a high-performance mode (HPM); and configure the at least one communication chain in the LPM or the HPM based on the rank and the one or more MCS thresholds associated with the rank.
Aspect 15: The apparatus of Aspect 14, wherein the rank is selected based on an MCS to be used for the communication.
Aspect 16: The apparatus of Aspect 15, wherein the one or more processors are further configured to receive a grant for the communication, wherein the grant indicates the MCS.
Aspect 17: The apparatus according to any of Aspects 14-16, wherein, to configure the at least communication chain in the LPM or the HPM, the one or more processors are configured to compare an MCS to be used for the communication with the one or more MCS thresholds associated with the rank.
Aspect 18: The apparatus of Aspect 17, wherein: the one or more MCS thresholds comprise a first MCS threshold and a second MCS threshold greater than the first MCS; and to configure the at least one communication chain in the LPM or the HPM, the one or more processors are configured to: configure the at least one communication chain in the LPM based on the MCS being less than the first MCS threshold; or configure the at least one communication chain in the HPM based on the MCS being greater than the second MCS threshold.
Aspect 19: The apparatus according to any of Aspects 14-18, wherein: the at least one communication chain includes a phase-locked loop (PLL) including a first VCO and a second VCO, the second VCO being configured to consume less power than the first VCO; and to configure the at least one communication chain, the one or more processors are configured to configure the PLL to use the second VCO in the LPM or use the first VCO in the HPM.
Aspect 20: A wireless device with two or more receive chains including: a first receive chain; and a second receive chain, at least one receive chain of the two or more receive chains including one or more adjustable components, the at least one receive chain being configured to operate in a first mode or a second mode, the first mode being associated with adjusting the one or more adjustable components to consume less power than the second mode, wherein the at least one receive chain is configured to switch between operating in the first mode and the second mode based on whether one or both of the first receive chain and the second receive chain are active for communication and a modulation and coding scheme (MCS) being used for the communication.
Aspect 21: The wireless device of Aspect 20, wherein a threshold MCS is used to determine whether to switch between operating in the first mode and the second mode.
Aspect 22: The wireless device according to any of Aspects 20-21, wherein the two or more receive chains comprises a third receive chain and a fourth receive chain.

### Additional Considerations

The above description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

1. A method for wireless communications, comprising:
selecting a rank of a plurality of ranks to be used for communication via at least one communication chain, the rank indicative of a number of active communication chains including the at least one communication chain, each of the plurality of ranks being associated with one or more modulation and coding scheme (MCS) thresholds used to transition between a low-power mode (LPM) or a high-performance mode (HPM); and
configuring the at least one communication chain in the LPM or the HPM based on the rank and the one or more MCS thresholds associated with the rank.

2. The method of claim 1, wherein configuring the at least one communication chain in the LPM includes controlling one or more adjustable components of the at least one communication chain to consume less power as compared to the HPM.

3. The method of claim 1, wherein the rank is selected based on an MCS to be used for the communication.

4. The method of claim 3, further comprising receiving a grant for the communication, wherein the grant indicates the MCS.

5. The method of claim 1, further comprising comparing an MCS to be used for the communication with the one or more MCS thresholds associated with the rank, the at least one communication chain being configured in the LPM or the HPM based on the comparison.

6. The method of claim 5, wherein:
the one or more MCS thresholds comprise a first MCS threshold and a second MCS threshold greater than the first MCS; and
configuring the at least one communication chain in the LPM or the HPM further includes:
configuring the at least one communication chain in the LPM based on the MCS being less than the first MCS threshold; or
configuring the at least one communication chain in the HPM based on the MCS being greater than the second MCS threshold.

7. The method of claim 1, wherein:
the at least one communication chain includes a phase-locked loop (PLL) including a first VCO and a second VCO, the second VCO being configured to consume less power than the first VCO; and
configuring the at least one communication chain comprises configuring the PLL to use the second VCO in the LPM or use the first VCO in the HPM.

8. The method of claim 7, wherein the first VCO and the second VCO comprise inductor-capacitor (LC) VCOs.

9. The method of claim 1, wherein configuring the at least one communication chain in the LPM includes bypassing at least one of an amplifier or a filter of the at least one communication chain.

10. The method of claim 1, wherein:
configuring the at least one communication chain in the LPM includes configuring the at least one communication chain to use a first digital filter mode to process a received signal in a digital domain; and
configuring the at least one communication chain in the HPM includes configuring the at least one communication chain to use a second digital filter mode to process the received signal in the digital domain, the first digital filter mode consuming less power than the second digital filter mode.

11. The method of claim 1, wherein:
configuring the at least one communication chain in the LPM includes using a first quantity of gain states for the at least one communication chain; and
configuring the at least one communication chain in the HPM includes using a second quantity of gain states for the at least one communication chain, the second quantity of gain states being more than the first quantity of gain states.

12. The method of claim 1, wherein the rank corresponds to a quantity of communication chains in the at least one communication chain.

13. The method of claim 1, wherein the communication chain comprises a receive chain.

14. An apparatus for wireless communications, comprising:
memory; and
one or more processors coupled to the memory and configured to:
select a rank of a plurality of ranks to be used for communication via at least one communication chain, the rank indicative of a number of active communication chains including the at least one communication chain, each of the plurality of ranks being associated with one or more modulation and coding scheme (MCS) thresholds used to transition between a low-power mode (LPM) or a high-performance mode (HPM); and
configure the at least one communication chain in the LPM or the HPM based on the rank and the one or more MCS thresholds associated with the rank.

15. The apparatus of claim 14, wherein the rank is selected based on an MCS to be used for the communication.

16. The apparatus of claim 15, wherein the one or more processors are further configured to receive a grant for the communication, wherein the grant indicates the MCS.

17. The apparatus of claim 14, wherein, to configure the at least communication chain in the LPM or the HPM, the one or more processors are configured to compare an MCS to be used for the communication with the one or more MCS thresholds associated with the rank.

18. The apparatus of claim 17, wherein:
the one or more MCS thresholds comprise a first MCS threshold and a second MCS threshold greater than the first MCS; and
to configure the at least one communication chain in the LPM or the HPM, the one or more processors are configured to:
configure the at least one communication chain in the LPM based on the MCS being less than the first MCS threshold; or
configure the at least one communication chain in the HPM based on the MCS being greater than the second MCS threshold.

19. The apparatus of claim 14, wherein:
the at least one communication chain includes a phase-locked loop (PLL) including a first VCO and a second VCO, the second VCO being configured to consume less power than the first VCO; and
to configure the at least one communication chain, the one or more processors are configured to configure the PLL to use the second VCO in the LPM or use the first VCO in the HPM.

20. A wireless device with two or more receive chains including:
a first receive chain; and
a second receive chain, at least one receive chain of the two or more receive chains including one or more adjustable components, the at least one receive chain being configured to operate in a first mode or a second mode, the first mode being associated with adjusting the one or more adjustable components to consume less power than the second mode, wherein the at least one receive chain is configured to switch between operating in the first mode and the second mode based on whether one or both of the first receive chain and the second receive chain are active for communication and a modulation and coding scheme (MCS) being used for the communication.
